(19) United States
(12) Patent Application Publication
(10) Pub. No.: US 2013/0206577 A1
(43) Pub. Date: Aug. 15, 2013

(54) PROCESS AND PLANT FOR THE DISTILLATION OF TEMPERATURE-SENSITIVE LIQUIDS

(71) Applicants: Jochen Bauer, Essen (DE); Frank Castillo-Welter, Friedrichsdorf (DE); Klaus Kirsten, Mainz (DE); Markus Kreich, Otzberg (DE); Christoph Steden, Oberursel (DE); Dominic Walter, Darmstadt (DE); Rudolf Zeyen, Frankfurt am Main (DE)

(72) Inventors: Jochen Bauer, Essen (DE); Frank Castillo-Welter, Friedrichsdorf (DE); Klaus Kirsten, Mainz (DE); Markus Kreich, Otzberg (DE); Christoph Steden, Oberursel (DE); Dominic Walter, Darmstadt (DE); Rudolf Zeyen, Frankfurt am Main (DE)

(73) Assignee: Lurgi GmbH, Frankfurt am Main (DE)

(21) Appl. No.: 13/809,621

(22) PCT Filed: Jun. 8, 2011
(86) PCT No.: PCT/EP2011/059520

§ 371 Date: Mar. 21, 2013

(30) Foreign Application Priority Data
Jul. 11, 2010 (DE) 102010026835.6

(51) Int. Cl. B01D 3/26

(52) U.S. Cl. CPC B01D 3/26
USPC 203/8; 203/98; 203/81; 202/161

(57) ABSTRACT

For the distillation of temperature-sensitive liquids, in particular acrylic acid and its esters, the liquid is heated in a column and at least partly evaporated. The vapor is guided through a condenser provided inside the column, in which the vapor is at least partly condensed. The condensed liquid is at least partly withdrawn from the column. The distillation is characterized in that the vapor not condensed yet is guided through the condenser cocurrently to the condensed liquid.

### CROSS-REFERENCE TO RELATED APPLICATIONS

This application is a national stage application under 35 U.S.C. 371 of International Patent Application Serial No. PCT/EP2011/059520, entitled “Verfahren und Anlage zur Destination von temperaturempfindlichen Flüssigkeiten,” filed Jun. 8, 2011, which claims priority from German Patent Application No. 10 2010 026 835.6, filed Jul. 11, 2010, the disclosures of which are hereby incorporated by reference herein in their entirety.

### FIELD OF THE INVENTION

This invention relates to a process and a plant for the distillation of temperature-sensitive liquids, in particular of acrylic acid and its esters, wherein the liquid is heated and at least partly evaporated in a column, wherein the vapor is guided through a condenser provided inside the column, in which the vapor is at least partly condensed, and wherein the condensed liquid is at least partly withdrawn from the column.

### BACKGROUND

Distillation refers to a thermal separation process which serves to separate a mixture of various substances soluble in each other. The starting mixture initially is brought to the boil. The resulting vapor, which is composed of the various components of the solution to be separated, is condensed in a condenser and subsequently the liquid condensate is collected. The separation effect is based on the different composition of the boiling liquid and the gaseous vapor, which requires different boiling points of the components to be separated.

Temperature-sensitive substances are considered to be those compounds which already tend to be decomposed and/or polymerized when their boiling point is exceeded by 10 to 50° C. An example for such temperature-sensitive substance is acrylic acid (C₃H₄O₂), which tends to polymerize in an explosion-like manner (polymerization enthalpy=75 kJ/mol). For storage at temperatures of about 20° C., acrylic acid therefore is first mixed with inhibitor, in order to limit the polymerization rate. In the distillation of acrylic acid, temperatures below 100° C. usually are desirable in the column sumps with short retention times at the same time.

EP 1 097 742 A1 describes a process for the distillation of acrylic acid, in which the vapors obtained in the distillation column are guided from the column head into an external condenser, usually a shell-and-tube condenser, in which their main part is condensed. The low boilers, i.e. components with a lower boiling point than acrylic acid, are condensed out in an aftercondenser, wherein the condensers are operated with cooling water in a temperature range between 30 and 50° C.

EP 1 475 364 A1 likewise relates to the distillation of acrylic acid or its esters and especially describes how a polymerization inhibitor can already be added into the distillation column and a polymerization in the column thus can effectively be prevented. Here as well, the condenser is provided outside the column.

A column with external condenser is expensive, in particular when a shell-and-tube condenser is used. Such processes are cost-intensive above all when a high vacuum is employed for the distillation. The high costs result from the fact that because of the low pressure (due to the high vacuum) and the resulting low gas density (and hence very high gas velocities) the vapor conduit between column and condenser must have a very large diameter. Typically, pipe conduits with a diameter in the range between 0.8 and 2 m are used here, wherein these dimensions very much depend on the capacity of the plant and the respective position of the column in the total system of the plant and hence the required vacuum. In a relatively large plant, the conventional top vapor conduits of columns with deep vacuum (columns with high acrylic acid concentration in the sump) would lie in the order of magnitude of 1.5-2 m. These pipe conduits require a high expenditure for their support and a correspondingly expensive steel construction.

The exhaust conduit between column and condenser in addition must be heated in the case of a condenser provided outside the column or must at least be insulated very well, so that no acrylic acid is condensed, which may polymerize and in the course of time build up layers which reduce the cross-section of the conduit. In some applications, this exhaust conduit also must additionally be wetted with polymerization inhibitor.

The technical requirement to produce a rather low pressure loss in the exhaust conduit calls for rather short conduits and hence an arrangement of the condenser in direct vicinity of the column, preferably below its vapor outlet opening.

With an external condenser, the condensate is collected in a tank below the condenser and from there is charged in part as backflow onto the separation part of the column. Feeding back is effected above the collecting tank, so that an additional pump is required.

The integration of the condenser into the column would allow to omit the external tank and the necessary steel construction, since the tank is integrated as collecting tray below the condenser. Condenser and collecting tank form a unit which is integrated into the column.

The integrated arrangement allows to ensure the backflow to the separation stages of the column by means of gravity (without pump).

From EP 0 839 896 B1 there is known such integration of the condenser into the column for refining edible oils. Undesired free fatty acids here should be removed by distillation, without destroying the carotene contained in the oil. The crude oil or pretreated oil is distilled at a pressure of <6 Pa and a temperature of 160 to 200° C. and the free fatty acids contained in the oil are removed by condensation inside the distiller. For removing the free fatty acids, the mixture of oil and free fatty acids is exposed to an internal condenser which is operated in a temperature range between the melting point of the free fatty acids and a temperature below the condensation point.

A condenser integrated into the column and approached from below is less expensive than the external condenser, but has the disadvantage of a higher pressure loss.

Since vapor and liquid here move in counterflow, partial or complete “flooding” of the heat exchanger also may occur with a high load of the column, in which draining of the condensate is impeded by the vapor flowing upwards. This is particularly critical when the condensate is a temperature-sensitive condensate, which due to the longer retention time is decomposed and/or polymerized on the surface of the condenser.

Attempts are being made to technically eliminate this problem by using pipes with larger diameter for the condenser. As a consequence of this measure, however, lower velocities and turbulences of the vapors in the interior of the condenser and hence a worse heat transfer coefficient are obtained. This in turn requires a greater specific heat exchanger surface and as a result higher costs and larger dimensions.

Both for an internal and for an external condenser, the pressure loss is a very important criterion, which must be taken into account in the design. This takes effect in particular when the distillation is carried out at reduced pressure, as is the case when the boiling temperature of the components should be lowered, in order to achieve a rather low thermal load of the products. This is connected with the fact that the pressure in the evaporator or column sump always is higher than the pressure in the column head or in the vacuum conduits, namely by the sum of the pressure losses of column and condenser. Higher pressure losses of the condenser thus enforce the generation of a higher vacuum. With increasing performance, e necessary equipment becomes more expensive and more maintenance-intensive.

In addition, the vacuum conduits between the condenser and the vacuum generator become more expensive, because the reduced pressure causes higher gas velocities which must he compensated with greater conduit cross-sections. Greater conduit cross-sections lead to additional costs both for the conduit itself and for its support and the steel construction.

The condensation of the exhaust vapors likewise becomes more difficult with higher vacuum. With decreasing pressure in the condenser, the difference between cooling water temperature and condensation temperature of the vapors is reduced. This can be counteracted on the one hand with a technically expensive and therefore costly decrease of the cooling water temperature or with a likewise expensive and costly increase of the specific heat exchanger surface of the condenser.

### SUMMARY

Therefore, it is the object of the present invention to provide for the distillation of temperature-sensitive liquids without additional technical expenditure with a low pressure loss at the same time.

This object is solved with the invention by a process with the features of claim 1 in that the temperature-sensitive liquid, in particular acrylic acid and its esters, is heated and at least partly evaporated in a column, wherein the vapor is guided through a condenser provided inside the column, in which the vapor is at least partly condensed, and wherein the condensed liquid is at least partly withdrawn from the column. The vapor not condensed yet is guided through the condenser cocurrent to the condensed liquid.

For this purpose, several packs of heat exchangers, preferably plate heat exchangers, are installed in the distillation column above the column internals. The vapors which reach the top of the column initially flow past the condenser pack almost unimpeded and are introduced from above, i.e. from the head of the column, into this condenser traversed first. On its cooled surface liquid is condensed, which due to gravity flows downwards in direction of the sump of the column, moves in the same direction as the vapor not condensed yet, whereby retention of liquid is safely prevented. Even high vapor loads, i.e. large mass flows of vapor, thus will not lead to flooding of the condenser. The condensed liquid film in part even is pushed into the collecting tray accelerated by the vapor volume.

At this condenser traversed first, preferably the largest part of the condensable vapors is liquefied, since this simplifies the design of the plant.

The condensate can be collected in a condensate collector which preferably is arranged in the interior of the column, whereby the condensate is not cooled and a correspondingly high technical expenditure for insulating pipes which extend outside the column is avoided. One part of the collected condensate is discharged from the column, another part is again charged to the column.

According to a preferred aspect of the invention, the temperature profile of the column can be controlled in that the amount of condensate withdrawn serves as actuating variable. The position of the condensate collector in the interior of the column and possibly above other column internals, such as separation trays etc., here provides for controlling not the quantity fed back, but the quantity of condensate withdrawn. Usually, a part of the liquid top product of a column, i.e. the vapors condensed by the condenser, is charged back to the column as backflow, while the other part is discharged to the outside. Due to the position of the condensate collector above the separation stages, e.g. distillation trays, the backflow can be controlled indirectly by varying the quantity discharged to the outside, i.e. when the quantity guided to the outside is reduced, the backflow correspondingly will be increased by the quantity Which no longer is guided to the outside. The condensate not withdrawn flows downwards from the condensate collector onto further column internals, in particular the separation means provided, and controls the temperature profile of the column in the same way as in the prior art, which is based on a control of the condensate fed back.

In the prior art, the entire quantity of condensed vapors (entire liquid top product) is conveyed by means of a pump (in some cases two pumps are used: backflow pump+discharge pump). The backflow to be adjusted to the column usually is adjusted in a flow-controlled manner via a control valve. The quantity to be discharged results from the total quantity of vapors, which was condensed and was not charged to the column as backflow. In most cases, the quantity discharged is controlled via a liquid level controller at the condensate collecting tank, which keeps the level constant and hence discharges the excess quantity which is not required as backflow. In the arrangement described above, the back-flow quantity need not be pumped, but can be guided via gravity from the collecting tray to the separation stages of the column located below the same. In this way, the feedback pump necessary with an external condensate collecting tank is saved. This solution is advantageous in particular when the size of the condensate collector is designed such that without further valves and other control devices the suitable amount of condensate is recirculated into the column through the overflow itself. Of course, however, other possibilities for controlling the volume flow are also conceivable.

To achieve a rather complete condensation of the component to be separated, one aspect of the invention provides to connect several condensers in series, wherein the second and/or further condensers can be operated both in cocurrent and in countercurrent flow.

it is particularly advantageous when the first condenser is traversed with coolant, with a temperature of about 18 to 40° C., preferably 25 to 35° C., and the second condenser is traversed with a coolant with a temperature of about 1 to 20° C., preferably 5 to 15° C. The coolant preferably is water, but can also be e.g. a water/ethylene glycol mixture.

The second condenser can be traversed both in countercurrent flow and after deflection of the vapors again in cocurrent flow. On the surface of the downstream condenser or the downstream condensers, the residual vapors of the high-boiling components are condensed as well as an amount of lower-boiling components larger than at the condenser traversed first. The condensate of the second condenser therefore preferably is collected separate from the condensate of the first condenser and is discharged completely, without again being passed to the column. The advantage of the separation of the lower-boiling components from the condensate of the first condenser consists in that these condensates are less suitable to control the temperature profile. Low boilers show a behavior in a separation column similar to inert gases, which cause turbulences and increased gas flows and hence deteriorate the separation efficiency of a column.

However, it also lies within the scope of the invention to mix the condensate streams of two, several or all condensers and feed them back as mixture. This has the advantage of a technically simple configuration, since only one collecting device and one condensate collector are required.

To prevent a polymerization of condensed substances, it is advantageous to introduce a suitable inhibitor into the column. Advantageously, this inhibitor is introduced above all column internals, i.e. above the condenser, the condensate collector, the separating devices etc. It is particularly recommendable to apply the inhibitor from above by spraying or injecting the same onto the surfaces of the condenser or several condensers, since here crystals and as a result possible polymerization nuclei may form.

Furthermore, the invention also comprises a plant for the distillation of temperature-sensitive liquids, in particular of acrylic acid and its esters, which is suitable for carrying out the process according to the invention. This plant comprises a column in whose interior at least one condenser is arranged, wherein the column and/or the condenser traversed first is constructed such that in the condenser traversed first the vapor not condensed yet is guided cocurrent to the condensed liquid. The guidance of the vapor in cocurrent flow advantageously is achieved in that the entry of the vapor into downwardly directed condenser openings is prevented, so that the vapor first flows past the condenser further to the top into the head of the column and is deflected there into condenser openings, so that the flow direction now is deflected form the head to the sump of the column. Due to gravity, the condensate likewise runs from the head to the sump, so that vapor and condensate are guided in cocurrent flow. In technical terms, the deflection of the condensate can be effected by a multitude of possibilities. Thus, for example suitable valves are conceivable at the openings of the condenser directed towards the sump. Preferably, the deflection of the condensate however is effected in that the collecting device for the condensate is designed such that it shields those openings of the condenser which are oriented towards the sump. Condenser and collecting tray usually form a unit which is downwardly closed, so that no vapors flow in from below, but preferably from above or possibly in part also from the side at the upper end of the condenser.

An advantageous aspect of the plant furthermore provides that in the interior of the column a condensate collector is arranged, whereby the condensate automatically has the temperature existing at this position in the column. It is particularly favorable when the collecting device is dimensioned such that it also serves as condensate collector. According to a preferred aspect of the invention at least one, preferably all condenser(s) is/are a plate condenser, which can be constructed technically simple and is a comparatively inexpensive apparatus with a great heat-exchange surface at the same time.

Further developments, advantages and possible applications of the invention can also be taken from the following description of exemplary embodiments and the drawing. All features described and/or illustrated form the subject-matter of the invention per se or in any combination, independent of their inclusion in the claims or their back-reference.

### BRIEF DESCRIPTION OF THE FIGURES

FIG. 1 shows the schematic diagram of a distillation column according to the invention with two internal condensers, wherein both condensers are operated in cocurrent flow;

FIG. 2 shows the schematic diagram of a distillation column according to the invention with two internal condensers, wherein the first condenser is operated in cocurrent and the second in countercurrent flow;

FIG. 3 shows the schematic diagram of a distillation column according to the invention with two internal condensers, wherein the first condenser is operated in cocurrent and the second in countercurrent flow and both condensers have a common collecting device;

FIG. 4 shows the schematic diagram of a distillation column according to the invention with three internal condensers, wherein the first and the second condenser are operated in cocurrent and the third in countercurrent flow.

### DETAILED DESCRIPTION

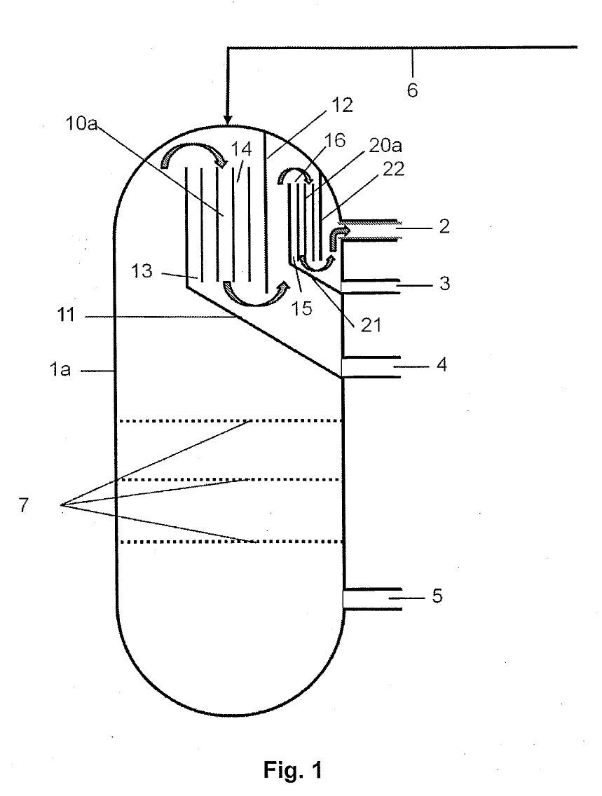

FIG. 1 shows a column 1a according to the invention, which at the head region, namely at the top, includes two condensers 10a, 20a. The heated vapor, in particular acrylic acid vapor, ascending in the column, is deflected via a drain plate 11 such that it cannot enter into the openings 13 of the condensers 10a, 20a directed downwards towards the sump, but flows past the condenser 10a. Above the condenser 10a, a deflection and shut-off device 12, which for example can be a further plate, prevents that the vapor can enter into the condenser 20a. Due to the enforced flow, as indicated by arrows, the vapor now flows into the upwardly directed openings 14 of the condenser 10a. In this condenser 10a, parts of the vapor are condensed out. The condensate precipitated at the walls of the condenser 10a runs downwards due to gravity, where it is guided through a collecting device 11 to drainage 4 of condensates with lower content of low boilers.

The still gaseous constituents flow past the deflection device 12 to the second condenser 20, as is indicated by arrows. In the condenser 20a, as already in the condenser 10a traversed first, a device for collecting the condensate in the column schematically shown in FIG. 1 prevents that the vapor enters into the openings 15 of the condenser 20a oriented towards the sump. Instead, a collecting device 21 directs the steam along the deflection device 12 past the condenser 20a, so that the vapor enters into the upwardly oriented openings 16 of the second condenser 20a. Like also in the condenser 10a traversed first, the vapor together with the condensate formed now flows in cocurrent flow in direction of the sump of the column 1a. Condensate formed is collected in the collecting device 21 and discharged through a drainage 3 of condensates with higher content of low boilers. Remaining vapor flows past a further deflection device 22 into a drainage 2 of the non-condensed constituents to the vacuum system or to the recirculation into the column 1a.

Conduit 5 is representative of the possibility to withdraw further components from the sump of the column 1a and/or to feed the feed (feed stream) or parts of the feed into the column 1a. What is also shown schematically are column internals 4 contained in the column 1a, such as liquid distributors, separating and collecting trays, supporting grates, hold-down grates, droplet separators, gas distributors, packings, packed beds and special components.

Conduit 6 represents a conduit for supplying an inhibitor for preventing a polymerization. This inhibitor for example can be introduced into a non-illustrated distributor system at the head of the column la and from there spread in the column 1a. Since crystallization nuclei from which a polymerization can proceed, may form on each surface, it is particularly favorable to spread the polymerization inhibitor directly over internals such as the condensers 10a, 20a, for example by spraying on directly. Alternatively, a nozzle can also be provided at the head of the column 1a, which atomizes the inhibitor. What is also promoted here above all is a rather complete wetting of the condenser 10a traversed first, since from there inhibitor can be guided through the vapor and the liquid onto other components of the column 1a. In dependence on the composition of the vapors to be condensed, the inhibitor can be supplied to both all condensers and only some or only the main condenser.

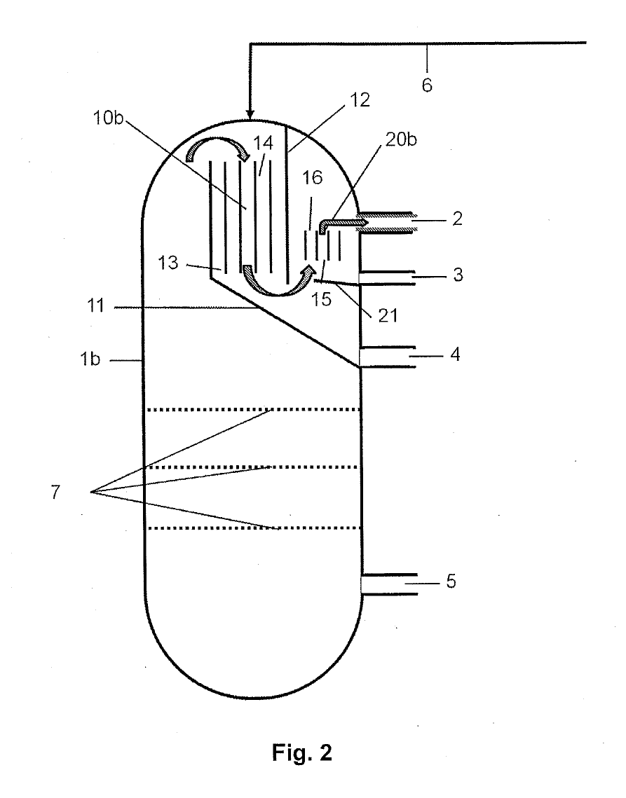

FIG. 2 shows a column 1b according to a second embodiment with two internal condensers 10b, 20b. After traversing the condenser 10b in cocurrent flow with the condensate obtained there, the vapor here however is not prevented by the collecting device 21 from directly entering into the condenser 20b. Rather, as indicated by arrows, the vapor flows past the collecting device 21, enters into the openings 15 of the condenser 20b oriented downwards, in direction of the sump, and traverses the same from the bottom to the top. Resulting condensate simultaneously flows from the head to the sump, so that condensate and vapor are countercurrently guided in the condenser 20b. Here as well, the condensate of the second condenser 20b is collected in the separate collecting device 21 and discharged through the drainage 3. Remaining vapor is discharged through the drainage 2.

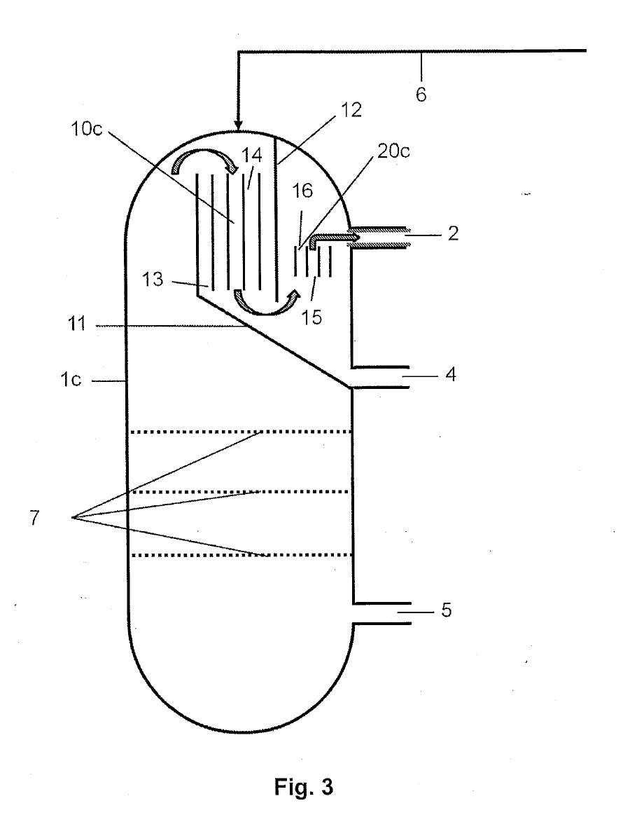

In the third embodiment shown in FIG. 3, the vapor is guided like in FIG. 2 in the condenser 10c traversed first in cocurrent flow with the condensate obtained, and in the second condenser 20c it is guided countercurrent to the condensate obtained. In this embodiment, a second means for collecting the condensate, which is obtained in the condenser 20c, has been omitted. Condensate which is obtained in the condenser 20c drips into the collecting device 11, in which there is also collected the condensate from the condenser 10c traversed first. The mixture of the two condensate streams is withdrawn from the column 1c via the drainage 4. The remaining vapor flows off through the drainage 2.

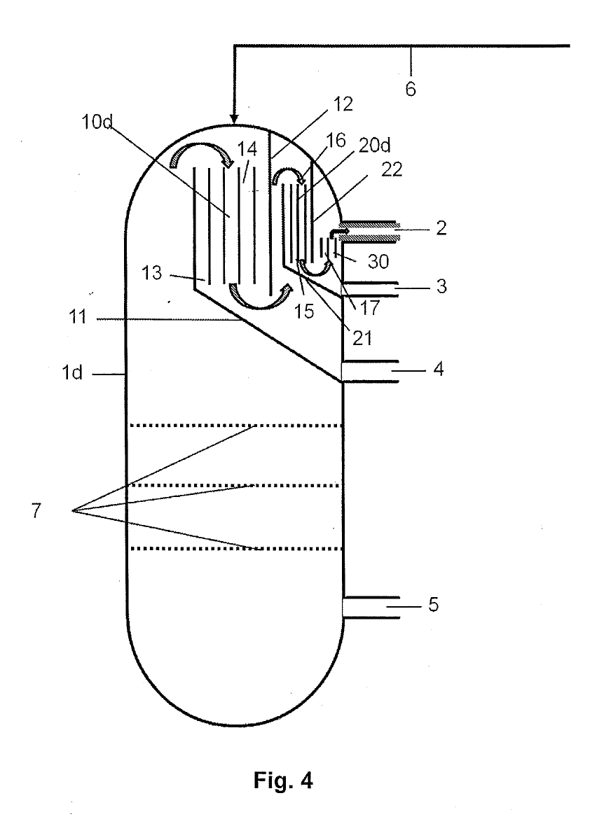

In the fourth embodiment according to FIG. 4, there are shown three condensers 10d, 20d and 30 lying in the interior of the column 1d. The vapor enters into the condenser 10d traversed first such that it is guided in cocurrent flow with the condensate obtained in the condenser 10d. The second condenser 20d also is operated in cocurrent flow similar to the first embodiment. After exit from the condenser 20d, the vapor still present, as indicated by arrows, flows into the openings 17 of the third condenser 30 oriented in direction of the sump, so that here a guidance countercurrent to the liquid condensate of the condenser 30 is effected. In principle, however, a cocurrent guidance of the vapor also is possible in the third condenser 30.

With regard to the temperature of the cooling water used, the third condenser 30 just like the condenser 20d can be traversed by the same cooling water as the condenser 10d traversed first. The third condenser 30 also can be operated with cooling water which has the same temperature as the cooling water used in the condenser 20d, or the third condenser 30 is operated with a cooling water with a third temperature, wherein this temperature preferably lies between or below the cooling water temperature of the two other condensers 10d and 20d.

The condensates of the third and further possible condensers may be added both to the condensate of the first condenser 10d and to the condensate of the second condenser 20d or be discharged via a separate conduit.

### EXAMPLES

In an existing plant for producing 30,000 t of acrylic acid per year the acrylic acid is distilled for purification. In the distillation means used for this purpose, a shell-and-tube condenser is mounted above the separating part with eight theoretical trays outside the column, which is approached with vapor from below. This set-up substantially corresponds to the external condenser described in EP 1 475 364 A1.

Under normal operating conditions, this shell-and-tube condenser causes a pressure loss of 2.5 kPa. With normal operation of the plant, the separating part of the column located thereunder causes a further pressure loss of 9.5 kPa, so that the entire column has a total pressure loss of 12 kPa. At normal production rates, the installed vacuum system generates an absolute pressure of 7 kPa. With this configuration, which corresponds to the prior art, a pressure of about 20 kPa thus is obtained in the evaporator, and a corresponding boiling point of the bottom product containing acrylic acid of about 96° C.

By replacing the head part of the column, the column can be equipped in accordance with the invention. The flange-mounted shell-and-tube heat exchanger is removed and a plate condenser according to the invention described here is installed in the interior of the column. The pressure loss of the condenser thereby drops from 2.5 kPa. to <0.2 kPa. By this measure alone and without changing the separating part of the column or the vacuum system, a pressure decrease in the evaporator by <2 kPa thus is achieved with unchanged plant capacity. Hence, the absolute pressure in the evaporator drops from about 20 kPa to about 18 kPa. As a result of the pressure thus reduced, the boiling point of the bottom product is reduced from about 96° C. to <93° C.

Due to this reduction of the bottom temperature, the distillation column not only can be operated more efficiently in energetic terms, but the polymerization tendency of the product and its thermal breakdown also are recognizably reduced: The amount of dimer formed from the undesired side reaction of the acrylic acid decreases due to this measure from about 110 kg/h to <75 kg/h; the product color of the contained acrylic acid is improved due to this measure from about 8 to about 7 units (“Hazen” color index according to APHA).

The installation costs of the system lie more than 30% below the variants known from the prior art.

### LIST OF REFERENCE NUMERALS

1a-d column
2 conduit
3 conduit
4 conduit
5 conduit
6 conduit
7 column internals
10a-d condenser
11 collecting device of the condensate
12 separating device
13-17 condenser openings
20a-d condenser
21 collecting device of the condensate
22 separating device
30 condenser

1. A process for the distillation of temperature-sensitive liquids, wherein the liquid is heated and at least partly evaporated in a column, wherein the vapor is guided through a condenser provided inside the column, in which the vapor is at least partly condensed, and wherein the condensed liquid is at least partly withdrawn from the column, wherein the vapor not condensed yet is guided through the condenser cocurrently to the condensed liquid.

2. The process according to claim 1, wherein the condensate is collected in a condensate collector mounted in the interior of the column, wherein one part of the collected condensate is discharged from the column and the other part of the collected condensate is again charged to the column, and wherein the temperature profile of the column is controlled by the amount of condensate discharged.

3. The process according to claim 1, wherein in the column at least two series-connected condensers are provided, wherein the second condenser and/or further condensers are operated in cocurrent or countercurrent flow.

4. The process according to claim 3, wherein the first condenser is operated with cooling medium with a temperature of 18 to 40° C., and at least one further condenser is operated with cooling medium with a temperature of 1 to 20° C.

5. The process according to claim 3, wherein the condensate of the second and/or at least one further condenser is collected separate from the condensate of the first condenser and is discharged completely without recirculation to the column.

6. The process according to claim 3, wherein the condensate of the second condenser and/or at least one further condenser is discharged together with condensate of the first condenser and fed back as mixture.

7. The process according to claim 1, wherein a polymerization inhibitor is introduced into the column.

8. A plant for the distillation of temperature-sensitive liquids, with a column in whose interior at least one condenser is arranged, wherein the column or the condenser traversed first is constructed such that in the condenser traversed first the vapor not condensed yet is guided cocurrently to the condensed liquid.

9. The plant according to claim 8, wherein in the interior of the column a collecting device for the condensate is arranged.

10. The plant according to claim 8, wherein at least one condenser is a plate condenser.

11. The process according to claim 1, wherein the temperature-sensitive liquid comprises acrylic acid and its esters.

12. The process according to claim 4, wherein the first condenser is operated with cooling medium with a temperature of 25 to 35° C. and at least one further condenser is operated with cooling medium with a temperature of 5 to 15° C.

13. The process according to claim 7, wherein the polymerization inhibitor is introduced into the column above all column internals.

14. The process according to claim 7, wherein the polymerization inhibitor is sprayed into the main condenser and/or the other condensers.

15. The plant according to claim 8, wherein the temperature-sensitive liquids comprises acrylic acid and its esters.
